(19) United States
(12) Patent Application Publication
(10) Pub. No.: US 2008/0078220 A1
(43) Pub. Date: Apr. 3, 2008

(54) Locking Apparatus Having a Latch Bolt Separated from Cylinder

(75) Inventor: Gab-Sik Kim, Seoul (KR)

Correspondence Address: BIRCH STEWART KOLASCH & BIRCH, PO BOX 747, FALLS CHURCH, VA, 22040-0747, US

(73) Assignee: Unipass Co., Ltd., Seoul (KR)

(21) Appl. No.: 11/597,695

(22) PCT Filed: May 27, 2005
(86) PCT No.: PCT/KR05/01583

§ 371 Date: Feb. 2, 2007

(30) Foreign Application Priority Data
May 27, 2004 (KR) 10-2004-0037880

(51) Int. Cl. E05B 49/00

(52) U.S. Cl. 70/283.1

(57) ABSTRACT

Disclosed is a locking apparatus having a latch bolt separated from a cylinder. The locking apparatus includes a housing, a cylinder rotating within the housing, a slider forwarding or reversing along a shaft direction of the cylinder, a latch mechanism disposed in front of the slider and fixed to the slider when the slider forwards but released from the slider when the slider reverses, and a means for forwarding or reversing the slider. Thus, since the locking apparatus has a simple structure, it has an advantage in that it can be replaced with the conventional locking apparatus having a complicated structure.

### TECHNICAL FIELD

The present invention relates to a locking apparatus, and more particularly, to a locking apparatus having a latch bolt separated from a cylinder.

### BACKGROUND ART

A locking apparatus is designed in such a manner that a door of an object provided with the locking apparatus is opened after a key is inserted into a cylinder to rotate the cylinder and thus move a latch bolt connected with the cylinder.

A latch bolt of a general locking apparatus is mechanically connected with a cylinder.

However, such a structure that the latch bolt is mechanically connected with the cylinder has limitation in ensuring safety essential to the locking apparatus. Most of the locking apparatuses are designed in such a manner that a key having no approval cannot be inserted into a cylinder or the cylinder cannot be rotated even if such a key is inserted into the cylinder. However, if the cylinder is already rotated, the latch bolt is driven to open the door. Therefore, people who illegally try to open the door are likely to insert the key or another similar tool into the cylinder to rotate the cylinder, thereby opening the door.

### DISCLOSURE OF THE INVENTION

BRIEF DESCRIPTION OF THE DRAWINGS

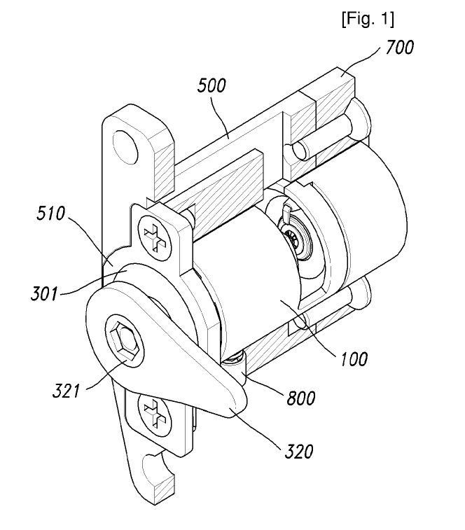

FIG. 1 is a perspective view illustrating the state that a locking apparatus according to the present invention is partially cut;

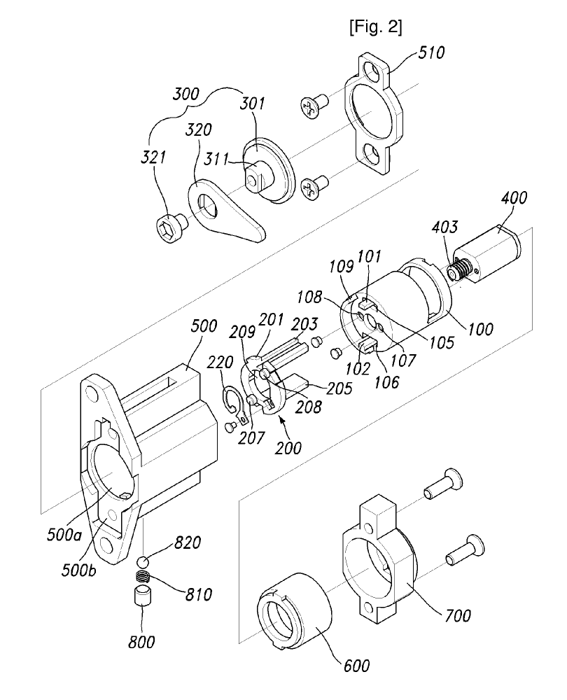

FIG. 2 is an exploded perspective view illustrating a locking apparatus according to the present invention;

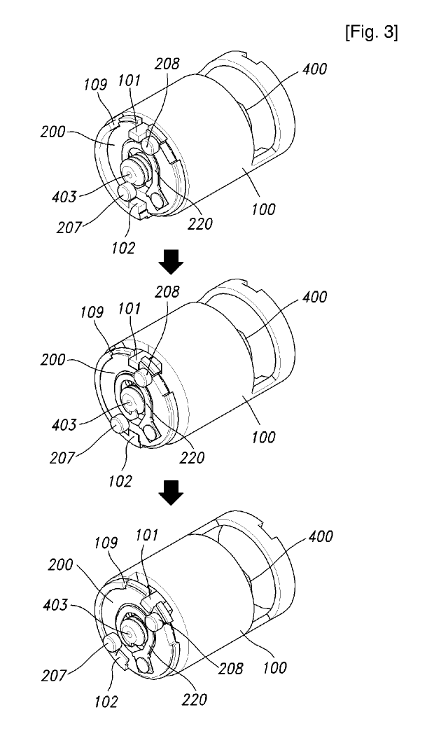

FIG. 3 is a perspective view illustrating the operation of a cylinder and a slider of a locking apparatus according to the present invention;

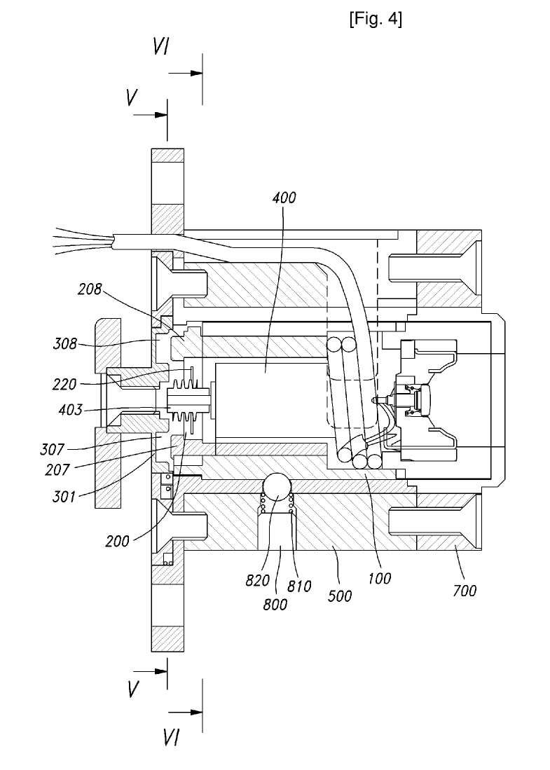

FIG. 4 is a sectional view illustrating a locking apparatus according to the present invention;

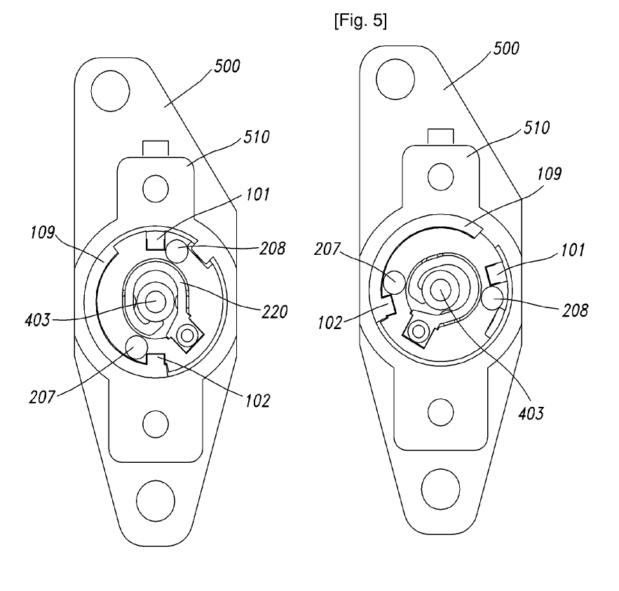

FIG. 5 is a sectional view taken along line V-V of FIG. 4; and

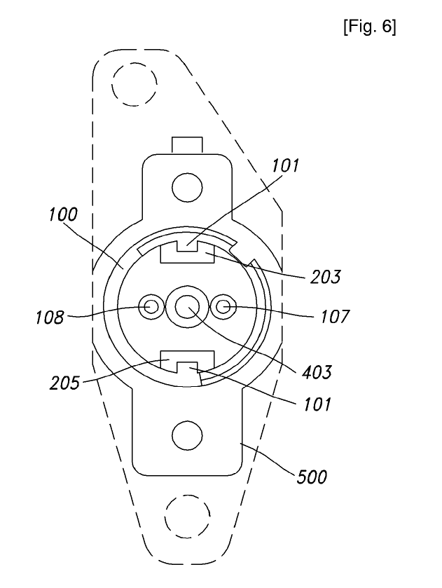

FIG. 6 is a sectional view taken along line VI-VI of FIG. 4.

### BEST MODE FOR CARRYING OUT THE INVENTION

An object of the present invention is to provide a locking apparatus in which a latch bolt is not operated even if a cylinder is rotated by an illegal method.

Another object of the present invention is to provide a locking apparatus in which a latch bolt cannot be operated even if a cylinder is broken.

The one object of the present invention can be achieved by providing a structure of a locking apparatus in which a latch bolt is usually separated from a cylinder except that a door is opened.

The other object of the present invention can be achieved by providing a structure of a locking apparatus in which a latch bolt is separated from a cylinder so as not to operate the latch bolt even if the cylinder is broken.

To achieve these and other advantages and in accordance with the purpose of the present invention, as embodied and broadly described, a locking apparatus according to the present invention includes a housing, a cylinder rotating within the housing, a slider forwarding or reversing along a shaft direction of the cylinder, a latch mechanism disposed in front of the slider and fixed to the slider when the slider forwards but released from the slider when the slider reverses, and a means for forwarding or reversing the slider.

The cylinder substantially has a cylindrical shape, and is provided with guides formed in a cylindrical surface along a length direction of the cylinder. The means for forwarding or reversing the slider is provided in the cylinder.

A motor or a solenoid is used as the means for forwarding or reversing the slider. When the motor is used as the means for forwarding or reversing the slider, a worm gear is engaged with a shaft of the motor. The worm gear is disposed at a center portion of a body portion of the slider so that it is to be fixed to the slider.

In the present invention, the slider forwards or reverses along the shaft direction of the cylinder. The slider has a substantially cylindrical shaped body portion and leg portions backwardly extended from the body portion. Engagement bosses are forwardly protruded in the body portion of the slider. The leg portions are linearly driven in forward and reverse directions along the guides of the cylinder in a state that they are inserted into guide grooves of the cylinder. The body portion of the slider has a hole at the center portion. A connecting means is disposed in the center of the hole to connect the means for forwarding or reversing the slider.

A plate spring is used as the connecting means. In this case, the plate spring is fixed to the body portion of the slider. The plate spring substantially has a fishing hook shape, and its one end is fixed to the body portion of the slider and its other end is fitted into the worm gear of the driving motor. Therefore, the plate spring moves in forward and reverse directions along the worm gear as the driving motor is driven. The leg portions of the slider move in forward and reverse directions along the guides of the cylinder as the plate spring moves in forward and reverse directions. As a result, the slider forwards or reverses.

The latch mechanism includes a latch engagement member. The latch engagement member is provided with engagement grooves at one side to face the engagement bosses of the slider. Therefore, if the slider forwards, the engagement bosses are engaged with the engagement grooves of the latch engagement member so that the slider is fixed to the latch mechanism. By contrast, if the slider reverses, the engagement bosses are released from the engagement grooves of the latch engagement member so that the slider is released from the latch mechanism. The latch engagement member is also provided with a latch bolt engagement boss at the other side to fix a latch bolt. The latch bolt is fitted into the latch bolt engagement boss.

In the present invention, a motor or a solenoid is constructed to be driven when a code stored in a ROM of a key is identical with a code of EEPROM provided in the locking apparatus. With respect to this structure, the technology of the Korean Patent Publication No. 2001-0001556 titled Electronic Lock System invented by the inventor of this invention could be used.

ROM keys used in the lock system disclosed in the Korean Patent Publication No. 2001-0001556 have unique electronic codes that cannot be deleted or changed. Keys having ROM with such electronic codes (referred to as ROM keys ) are stored in EEPROM of the system through an input terminal and perform their specific function when the electronic codes identified with those stored in the EEPROM are input.

Therefore, the ROM keys have different functions depending on which electronic codes of the ROM keys are stored in the EEPROM of the system. The ROM keys having the electronic codes stored in the EEPROM of the system with the same function have the same function as one another. It is therefore desirable that a memory area of the EEPROM is divided into parts to allow the electronic codes having the same function to be respectively stored therein.

In other words, ROM keys having electronic codes stored in one area perform the same function but those having electronic codes stored in different areas perform different functions. Such ROM keys are provided at various levels. For example, a ROM key of high level controls a ROM key of low level. That is, a ROM key of the first level, i.e., the highest level, stores an electronic code of a specific ROM key in the EEPROM of the system so that the electronic code is used as a ROM key of the second level. Alternatively, the ROM key of the first level is used to delete the electronic code of the specific ROM key and change the electronic code of the ROM key of the first level stored in the EEPROM. Further, the ROM key of the second level stores the electronic codes of the specific ROM keys in the EEPROM so that each electronic code is used as a ROM key of the third level or the fourth level. Alternatively, the

ROM key of the second level is used to delete the electronic codes of the specific ROM keys and perform a specific function. Whether the specific ROM key performs the function of the ROM key of the third level or the fourth level depends on that the electronic code of the specific ROM key has been stored in the EEPROM with which function of the ROM key of the second level. The ROM key of the third level stores the electronic code of the specific ROM key in the EEPROM so that it functions as the ROM key of the fourth level.

An electronic code of another ROM key previously stored in the EEPROM could be stored in the EEPROM or deleted from the EEPROM by controlling an ALU after inputting the electronic code of the ROM key previously stored in the EEPROM to RAM through an input terminal.

As described above, the electronic code of the ROM key previously stored in the EEPROM could be stored or deleted from a specific area when the ROM key is touched with the input terminal to allow the electronic code of the ROM key to be input to the RAM through the input terminal and the ALU identifies the electronic code.

Referring to FIG. 1 to FIG. 6, a cylinder device 100 is substantially provided with a housing 500 and rotates within the housing 500. The cylinder device 100 rotating within the housing 500 includes a cylinder 100 having a cylindrical shape, a slider 200, a latch mechanism 300, and a driving motor 400. The slider 200 forwards and reverses along a shaft direction of the cylinder 100. The latch mechanism 300 is positioned in front of the slider 200, and is fixed to the slider 200 when the slider 200 forwards but released from the slider 200 when the slider 200 reverses. The driving motor 400 is positioned in the cylinder 100 and allows the slider 200 to forward or reverse.

The cylinder 100 is provided with guides 101 and 102 formed in a cylindrical surface along a length direction of the cylinder 100. A clamp surface is formed at the front of the cylinder 100 to clamp the driving motor 400.

The clamp surface has a hollow shape to expose the rotational shaft of the driving motor 400 outside the cylinder 100. The guides 101 and 102 are partially opened to form guide grooves 105 and 106.

The clamp face is provided with screw holes 107 and 108 for fitting the motor. An extension 109 may partially be formed in the vicinity of the clamp surface as occasion demands. The extension 109 is extended a little longer than the clamp surface. The extension 109 determines a rotational range of the cylinder device when the cylinder device is mounted in the housing 500.

The slider 200 forwarding or reversing along the shaft direction of the cylinder 100 has a body portion 201 and leg portions 203 and 205. The body portion 201 has a substantially cylindrical shape, and the leg portions 203 and 205 are backwardly extended from the body portion 201. Engagement bosses 207 and 208 are forwardly protruded in the body portion 201 of the slider 200. The leg portions 203 and 205 are linearly driven in forward and reverse directions along the guides 101 and 102 in a state that they are inserted into the guide grooves 105 and 106. The body portion 201 of the slider 200 has a hole 209 at the center portion. A worm gear 403 of the driving motor 400 is disposed in the center of the hole 209. Meanwhile, the body portion 201 of the slider 200 is provided with a plate spring 220. The plate spring 220 substantially has a fishing hook shape, and its one end is fixed to the body portion 201 of the slider 200 and its other end is fitted into the worm gear 403 of the driving motor 400. Therefore, the plate spring 220 moves in forward and reverse directions along the worm gear 403 as the driving motor 400 is driven. The leg portions 203 and 204 of the slider 200 move in forward and reverse directions along the guides 101 and 102 of the cylinder 100 as the plate spring 220 moves in forward and reverse directions. As a result, the slider 200 forwards or reverses.

If the slider 200 forwards, the engagement bosses 207 and 208 are engaged with the latch mechanism 300 so that the slider 200 is fixed to the latch mechanism 300. By contrast, if the slider 200 reverses, the engagement bosses 207 and 208 are released from the latch mechanism 300 so that the slider 200 is released from the latch mechanism 300.

The latch mechanism 300 includes a latch engagement member 301. The latch engagement member 301 is provided with engagement grooves 307 and 308 at one side as shown in FIG. 4. The engagement grooves 307 and 308 face the engagement bosses 207 and 208 of the slider 200. Therefore, if the slider 200 forwards, the engagement bosses 207 and 208 are engaged with the engagement grooves 307 and 308 of the latch engagement member 301 so that the slider 200 is fixed to the latch mechanism 300. By contrast, if the slider 200 reverses, the engagement bosses 207 and 208 are released from the engagement grooves 307 and 308 of the latch engagement member 301 so that the slider 200 is released from the latch mechanism 300. The latch engagement member 301 is also provided with a latch bolt engagement boss 311 at the other side. The latch bolt engagement boss 311 serves to fix a latch bolt 320. A bolt 321 is fitted into the latch bolt engagement boss 311 to fix the latch bolt 320.

The driving motor 400 is disposed in the cylinder 100. The driving motor 400 is fixed to the clamp surface of the cylinder by a screw. The worm gear 403 is inserted into the rotational shaft of the driving motor 400. The worm gear 403 is released from the cylinder through the hole of the clamp surface. Then, the worm gear 403 is disposed in the hole 209 at the center portion of the body portion 201 so that one end of the plate spring 220 fixed to the body portion 201 can be fitted into the worm gear 403. Therefore, the plate spring 220 moves in forward and reverse directions along the worm gear 403 as the driving motor 400 is driven. The leg portions 203 and 204 of the slider 200 move in forward and reverse directions along the guides 101 and 102 of the cylinder 100 as the plate spring 220 moves in forward and reverse directions. As a result, the slider 200 forwards or reverses.

As shown in FIG. 2, the cylinder 100 and the slider 200 are fitted into the housing 500. A clamp member 510 is provided in a groove 500b at the front of the housing 500. The clamp member 510 serves to fix the engagement member 301. A hole 500a is also formed at the front of the housing 500 to fit the bolt 321 into the latch bolt engagement boss 311.

Furthermore, a socket 600 for contacting an electronic key and a clamp member 700 for fixing the socket 600 are formed at the rear of the housing 500. The socket 600 is fixed to the clamp member 700 in a state that the cylinder 100 is mounted in the housing 500.

Referring to FIG. 3, the drawing at the uppermost portion represents the cylinder 100 and the slider 200 before the key is inserted thereinto. The drawing at the middle portion represents the state that the slider 200 forwards as the motor 400 is driven after the key is inserted thereinto. In this case, the cylinder 100 is engaged with the latch mechanism 300 so that they rotate together. The drawing at the lowermost portion represents the state that the latch mechanism 300 and the cylinder 100 are rotated by turning the key after the cylinder 100 is engaged with the latch mechanism 300. In this case, the door is to be opened.

An inner structure of the locking apparatus will be described in more detail with reference to FIG. 4. A ball 820, a spring 810, and a plug 800 are sequentially provided in the housing 500. A groove into which the ball 820 is partially inserted is formed at the outer circumference of the cylinder 100 to support an initial position of the cylinder 100 well. If the key is inserted at the rear to match a contact point well, the motor 400 is driven to forward the slider 200. As a result, the cylinder 100 is engaged with the latch mechanism 300. In this state, if the key is turned, the latch mechanism 300 and the cylinder 100 are rotated together to open the door.

The left drawing of FIG. 5 corresponds to the same state as that of the uppermost drawing of FIG. 3. That is, the left drawing of FIG. 5 illustrates the state before the cylinder and the latch mechanism are not operated. The right drawing of FIG. 5 corresponds to the same state as that of the lowermost drawing of FIG. 3. That is, the right drawing of FIG. 5 illustrates the state that the cylinder 100 and the latch mechanism 300 are rotated in a state that the one is engaged with the other.

### INDUSTRIAL APPLICABILITY

As described above, since the locking apparatus of the present invention has a simple structure, it has an advantage in that it can be replaced with the conventional locking apparatus having a complicated structure.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

1. A locking apparatus comprising:
a housing;
a cylinder rotating within the housing;
a slider forwarding or reversing along a shaft direction of the cylinder;
a latch mechanism disposed in front of the slider and fixed to the slider when the slider forwards but released from the slider when the slider reverses; and
a means for forwarding or reversing the slider.
The locking apparatus according to claim 1, wherein the means for forwarding or reversing the slider is a motor.
The locking apparatus according to claim 1, wherein the means for forwarding or reversing the slider is a solenoid.
The locking apparatus according to any one of claim 1 to claim 3, wherein the latch mechanism is provided with a groove at one side and the slider is provided with bosses at a front surface, so that the slider is fixed to the latch mechanism when the bosses are inserted into the groove of the latch mechanism while the slider is released from the latch mechanism when the bosses are released from the groove of the latch mechanism.
